(19) United States
(12) Patent Application Publication
(10) Pub. No.: US 2025/0215168 A1
(43) Pub. Date: Jul. 3, 2025

(54) MODIFIED POST-CONSUMER RESIN SUITABLE FOR SHRINK FILMS

(71) Applicant: Braskem S.A., Camaçari (BR)

(72) Inventors: Marcelo Farah, São Paulo City (BR); Thais Nyland, São Paulo City (BR); Tadeu Mezacasa Forrest, São Paulo (BR)

(73) Assignee: Braskem S.A., Camaçari (BR)

(21) Appl. No.: 19/003,088

(22) Filed: Dec. 27, 2024

Related U.S. Application Data
(60) Provisional application No. 63/615,228, filed on Dec. 27, 2023.

(51) Int. Cl. C08J 5/18; B29C 35/02; B29K 23/00; C08J 3/22; C08J 3/24

(52) U.S. Cl. CPC C08J 5/18; B29C 35/0288; C08J 3/226; C08J 3/247; B29K 2023/0625; B29K 2995/0012; B29K 2995/0049; C08J 2323/06

(57) ABSTRACT

Modified post-consumer resin (PCR) suitable for shrink films, shrink films and articles comprising thereof and a method for preparing a shrink film. The modification of the PCR occurs by a free-radical initiator having a melt flow rate ranging from 0.01 to 1 g/10 min and it is added in an amount ranging from 100 to 1000 ppm based on the total weight of the modified PCR.

### BACKGROUND

Shrink films are commonly used in processes to label or wrap packages or containers. Such films should comprise elastic materials that are capable of returning to their previous orientation when heated and they are usually formed by polyolefins, especially polyethylenes.

Due to the increase of plastic waste in the world, there are many initiatives to reach a real circularity of the plastics, including mechanical or chemical recycling, new polymer blends comprising recyclable and virgin plastics and new applications.

Shrink films comprising blends of recyclable and virgin polyolefins are already known in the state of the art.

Document PCT/US2021/031480 discloses a shrink film being monolayer or multilayer having at least one layer of a post-consumer recycled resin and (i) a low-density polyethylene (LDPE), (ii) a linear low-density polyethylene (LLDPE) or a combination of (i) or (ii).

Document PCT/IB2020/054135 describes films, which can be selected from stretch films; shrink films; films for vacuum packages and films for dunnage packaging, and they are made from a recycled polyethylene composition comprising from 95 to 10 weight % polyethylene and 5 to 90 weight % of recycled polyethylene.

Blending post-consumer resins (PCR) with a virgin resin is usually necessary to achieve the desirable shrinkage percentage and further required properties for this kind of application. Particularly, it is usually necessary to blend the PCRs with a low-density polyethylene, in amounts of about 40 wt. % of LDPE in the blend, to reach the needed balance of elasticity versus shrinkage of the film.

However, it was surprisingly found that post-consumer resins modified by free-radical initiators achieve suitable properties for shrink films, without the need of blending with virgin polyolefins. Besides, due to this modification, mixture of sources comprising different polyethylene-based PCRs may be used without the need of selecting the materials. Such selection is expensive and restricts the available volume of post-consumer resins to be reused for shrink films.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a modified polyethylene-based post-consumer resin (PCR) suitable for shrink films, wherein the modified polyethylene-based PCR is a polyethylene-based PCR modified by a free-radical initiator.

In another aspect, embodiments disclosed herein relate to shrink films comprising a modified polyethylene-based post-consumer resin (PCR), wherein the modified polyethylene-based PCR is a polyethylene-based PCR modified by a free-radical initiator.

In further aspects, embodiments disclosed herein relate to an article wrapped by a shrink film comprising the modified polyethylene-based post-consumer resin (PCR) and to method for preparing a shrink film comprising the modified polyethylene-based PCR.

Other aspects and advantages of the claimed subject matter will be apparent from the following description and the appended claims.

### BRIEF DESCRIPTION OF DRAWINGS

FIG. 1 shows the influence of the modification on the MFR of PCR-A.

FIG. 2 shows the influence of the modification on the viscosity of PCR-A.

FIG. 3 shows the influence of the modification on the elasticity of PCR-A.

FIG. 4 shows the influence of the modification on the MFR of PCR-B.

FIG. 5 shows the influence of the modification on the viscosity of PCR-B.

FIG. 6 shows the influence of the modification on elasticity of PCR-B.

FIG. 7 shows the shrinkage at machine direction of PCRs A and B, and a reference sample.

FIG. 8 shows the shrinkage at transversal direction of PCRs A and B, and a reference sample.

FIG. 9 shows the puncture resistance (at maximum load) of PCRs A and B, and a reference sample.

FIG. 10 shows the total energy of PCRs A and B, and a reference sample.

FIG. 11 shows the apparency of the shrink films comprising PCR-A and B.

FIG. 12 shows the opacity effect in PCR-A and PCR-B.

FIGS. 13A-B show the shrink properties of the films obtained from PCR-A/B throughout the time.

FIG. 14 shows the reactivity difference between peroxides 1 and 2.

FIG. 15 shows the comparison of MFR reduction of PCRs A and B, using peroxides 1 and 2.

FIG. 16 shows the viscosity analysis of PCR-A modified with peroxides 1 and 2.

FIG. 17 shows the viscosity analysis of PCR-B modified with peroxides 1 and 2.

FIG. 18 shows the elasticity of PCR-A modified with peroxides 1 and 2.

FIG. 19 shows the elasticity of PCR-B modified with peroxides 1 and 2.

FIG. 20 shows the shrinkage at machine direction of PCRs A and B, and the reference sample using peroxide 2.

FIG. 21 shows the shrinkage at transversal direction of PCRs A and B, and the reference sample using peroxide 2.

FIG. 22 shows the puncture resistance (at maximum load) of PCRs A and B, and the reference sample using peroxide 2.

FIG. 23 shows the total energy of PCRs A and B, and the reference sample using peroxide 2.

FIG. 24 shows the opacity effect in PCR-A and PCR-B using peroxide 2.

### DETAILED DESCRIPTION

Embodiments disclosed herein relate to a modified polyethylene-based post-consumer resin (PCR) suitable for shrink films. The modified polyethylene-based PCR is a polyethylene-based PCR modified by a free-radical initiator having a melt flow rate ranging from 0.01 to 6 g/10 min measured according to ASTM D1238 (190° C., 2.16 Kg) and the free-radical initiator is present in an amount ranging from 100 to 2000 ppm based on the total weight of the modified PCR.

The polyethylene-based PCR modification described in the present invention occurs via reactive extrusion or via a mixture vessel at moderate temperatures. It was surprisingly found that the modification at moderate temperatures creates random branches on the polyethylene-based PCR, thus resulting in a desirable balance between elasticity and shrinkage for shrink film applications without the need of blending the PCR with virgin polyolefins.

The elasticity of a material is influenced from both i) the molecular weight of the material and its melt flow rate and ii) its branching degree. Hence, due to the new branches randomly introduced in the polyethylene-based PCR, it is possible to use mixture of sources of different PCRs comprising linear polymer, such as HDPE and LLDPE, for the intended application and reach the desirable shrinkage rates at machine direction (DM) and transversal direction (DT), without the need of blending with elastic polymers, such as virgin LDPE.

In the context of the present invention, the modification by a free-radical initiator of the polyethylene-based PCR should occur at moderate temperatures. Moderate temperatures mean from above the melt temperature of the PE-PCR, i.e., above 120° C., to below 300° C. In said temperature range, the mechanism of forming branches is dominant. Above 300° C., the mechanism of degradation reactions becomes dominant rather than forming branches, which is not the purpose of the present invention. Preferably, the modification occurs from 150 to 280° C. and most preferably occurs from 200 to 250° C.

In one embodiment of the present invention, the free-radical initiator is one or more peroxide compounds being selected from the group comprising wherein the peroxide is one or more of the group consisting of 3-hydroxy-1,1-dimethylbutyl peroxyneodecanoate, a-cumyl peroxyneodecanoate, 2-hydroxy-1,1-dimethylbutyl peroxyneoheptanoate a-cumyl peroxyneoheptanoate, t-amyl peroxyneodecanoate, t-butyl peroxyneodecanoate, di(2-ethylhexyl) peroxydicarbonate, di(n-propyl) peroxydicarbonate, di(sec-butyl) peroxydicarbonate, t-butyl peroxyneoheptanoate, t-amyl peroxypivalate, t-butyl peroxypivalate, diisononanoyl peroxide, didodecanoyl peroxide, 3-hydroxy-1,1-dimethylbutylperoxy-2-ethylhexanoate, didecanoyl peroxide, 2,T-azobis(isobutyronitrile), di(3-carboxypropionyl) peroxide, 2,5-dimethyl-2,5-di(2-ethylhexanoylperoxy)hexane, dibenzoyl peroxide, t-amylperoxy 2-ethylhexanoate, t-butylperoxy 2-ethylhexanoate, t-butyl peroxyisobutyrate, t-butyl peroxy-(cis-3-carboxy)propenoate, 1,1-di(t-amylperoxy)cyclohexane, 1,1-di(t-butylperoxy)-3,3,5-trimethylcyclohexane, 1,1-di(t-butylperoxy) cyclohexane, OO-t-amyl O-(2-ethylhexyl) monoperoxycarbonate, OO-t-butyl O-isopropyl monoperoxycarbonate, OO-t-butyl O-(2-ethylhexyl) monoperoxycarbonate, polyether tetrakis(t-butylperoxycarbonate), 2,5-dimethyl-2,5-di(benzoylperoxy)hexane, t-amyl peroxyacetate, t-amyl peroxybenzoate, t-butyl peroxyisononanoate, t-butyl peroxyacetate, t-butyl peroxybenzoate, di-t-butyl diperoxyphthalate, 2,2-di(t-butylperoxy)butane, 2,2-di(t-amylperoxy)propane, n-butyl 4,4-di(t-butylperoxy)valerate, ethyl 3,3-di(t-amylperoxy)butyrate, ethyl 3,3-di(t-butylperoxy)butyrate, dicumyl peroxide, a,a′-bis(t-butylperoxy)diisopropylbenzene, 2,5-dimethyl-2,5-di(t-butylperoxy) hexane, di(t-amyl) peroxide, t-butyl a-cumyl peroxide, di(t-butyl) peroxide, 2,5-dimethyl-2,5-di(t-butylperoxy)-3-hexyne, dicetil peroxi-dicarbonato, 3,6,9-triethyl-3,6,9-trimethyl-1,4,7-triperoxonane, tert-butylperoxy 2-ethylhexyl carbonate, tert-butyl-peroxide n-butyl fumarate(benzoate), dimyristoyl peroxydiicarbonate, 3,3,5,7,7-pentamethyl-1,2,4-trioxepane, tert-butyl hydroperoxide, bis(4-t-butylcyclohexyl) peroxydicarbonate, and 1,2,4,5,7,8-hexoxonane,3,6,9-trimethyl-3,6,9-tris(ethyl and propyl derivatives).

In a further embodiment, the free-radical initiator is one or more nitroxide compounds being selected from 2,2,5,5-tetramethyl-1-pyrrolidinyloxy, 3-carboxy-2,2,5,5-tetramethyl-pyrrolidinyloxy, 2,2,6,6-tetramethyl-1-piperidinyloxy, 4-hydroxy-2,2,6,6-tetramethyl-1-piperidinyloxy, 4-methoxy-2,2,6,6-tetramethyl-1-piperidinyloxy, 4-oxo-2,2,6,6-tetramethyl-1-piperidinyloxy, bis-(1-oxyl-2,2,6,6-tetramethylpiperidine-4-yl)sebacate, 2,2,.6,6-tetramethyl-4-hydroxypipe ridine-1-oxyl)monophosphonate, N-tert-butyl-1-diethylphosphono-2,2-dimethyl propyl nitroxide, N-tert-butyl-1-dibenzylphosphono-2,2-dimethylpropyl nitroxide, N-tert-butyl-1-di(2,2,2-trifluoroethyl)phosphono-2,2dimethylpropyl nitroxide, N-tert-butyl-(1-diethylphosphono)-2-methyl-propyl nitroxide, N-(1-methylethyl)-1-cyclohexyl-1-(diethylphosphono) nitroxide, N-(1-phenylbenzyl)-(1-diethylphosphono)-1-methyl ethylnitroxide, N-phenyl-1-diethylphosphono-2,2-dimethyl propyl nitroxide, N-phenyl-1-diethylphosphono-1-methyl ethyl nitroxide, N-(1-phenyl 2-methyl propyl)-1-diethylphosphono-1-methyl ethyl nitroxide, N-tert-butyl-1-phenyl-2-methyl propyl nitroxide, and N-tert-butyl-1-(2-naphthyl)-2-methyl propyl nitroxide.

In an alternative embodiment, the free-radical initiator may comprise a combination between a peroxide compound and a nitroxide compound.

According to the present invention, the free-radical initiator is present in an amount ranging from 100 to 2000 ppm based on the total weight of the modified PCR. In a preferred embodiment, the free-radical initiator is present in an amount ranging from 150to 1000 ppm, or 170 to 700 ppm and most preferably from 200 to 500 ppm.

The free-radical initiator may be added directly to the polyethylene-based PCR in an extruder, or it may be dosed with a carrier in the extruder. When dosed with a carrier, the mixture (carrier and the free-radical initiator) may comprise from 5 to 60 wt. % of the free-radical initiator, based on the total weight of the mixture, and preferably from 30 to 50 wt. % of the free-radical initiator. Suitable carriers may be selected from, but not limited to, talc, calcium carbonate, magnesium carbonate, silica, alumina, and others aluminosilicate. In an alternative embodiment, elastomers, olefinic plastomers or polyethylene masterbatches may be also used as suitable carriers, such as commercially available products named Vistamaxx™, Engage™, Exact™, Affinity™, Exceed™.

The modified polyethylene-based PCR according to the present invention has a melt flow rate of from 0.01 to 6 g/10 min, measured according to ASTM D1238 (190° C., 2.16 kg). In a preferred embodiment, the MFR of the modified polyethylene-based PCR ranges from 0.1 to 1 g/10 min, and more preferred from 0.2 to 0.6 g/10 min.

In one embodiment, the modified polyethylene-based PCR may be derived from a polyethylene-based PCR having a melt flow rate ranging from 0.5 to 10 g/10 min, measured according to ASTM D1238 (190° C., 2.16 kg), and preferably ranging from 0.8 to 5 g/10 min.

According to the present invention, the modified polyethylene-based PCR may be sourced from plastic waste used in shrink films, stretch films, or any other films with large available volume, and combinations thereof.

In one embodiment, the polyethylene-based PCR may be derived from a mixture of sources containing different PCRs wherein its final composition comprises greater than 50 wt. % of linear low-density polyethylene (LLDPE), preferably from 60 to 100 wt. % of LLDPE, 0 to 30 wt. % of low-density polyethylene (LDPE) and from 0 to 40 wt. % of high-density polyethylene (HDPE).

Further embodiments disclosed herein relate to shrink films comprising a composition comprising the modified polyethylene-based post-consumer resin (PCR) as described above. As the modified PCR of the present invention present desired shrinkage properties, it can replace directly virgin LDPE, which is the major component in usual formulations for shrink films available in the market, improving the possibilities of having a shrink film with a PCR content up to 100%.

Shrink films according to the present invention may have machine direction (MD) shrinkage of from 60 percent to 80 percent and a transversal direction (TD) shrinkage of from at least 20 percent, measured according to ASTM D2732 and ASTM D1204. In one embodiment, TD shrinkage ranges from 20 to 50 percent, preferably from 20 to 40percent.

The films disclosed in the present invention may be monolayer or multilayer, having at least one layer comprising the modified polyethylene-based post-consumer resin (PCR).

Alternatively, although it is not mandatory, a virgin polyethylene resin may be blended with the modified polyethylene-based PCR or added to the PCR before its modification to form the shrink films according to the present invention. In such embodiments, a virgin polyethylene resin may be added to improve the processability of the resin or to improve other properties of the film, such as stiffness, depending on the requirements of the final properties. A virgin polyethylene may be present in amounts up to 40 wt. %, based on the total weight of the film. The virgin resin may be selected from the group comprising a virgin high-density polyethylene (HDPE) and a virgin low-density polyethylene (LDPE).

Other compounds may be also blended with the modified resin to form the shrink films. In an embodiment of the present invention, the composition of the shrink films comprises at least one additive including, but not limited to, fillers, antioxidants, pigments, antiblockage, UV protectors, antibacterial, etc.

The present invention also relates to articles wrapped by the shrink films as described above. Such articles are found in many sectors in our daily lives, such as in the supermarket to wrap food and beverage packages.

The present invention still relates to a method for preparing a shrink film comprising the modified polyethylene-based PCR as described above. The method comprises:
modifying a polyethylene-based PCR by a free-radical initiator via reactive extrusion or via a mixture vessel, wherein the free-radical initiator is added in an amount ranging from 100 to 2000 ppm based on the total weight of the PCR, and
prepare the shrink film having a MD shrinkage of from 60 percent to 80 percent and a TD shrinkage of from at least 20 percent, measured according to ASTM D2732 and ASTM D1204.

The modification by the free-radical initiator occurs at moderate temperatures, i.e., from above 120° C. to below 300° C., preferably from 150 to 280° C.

According to the present invention, the free-radical initiator may be added in an extruder or in a mixture vessel. Besides, the free-radical initiator may be added directly in the equipment (extruder or mixture vessel) or it may be dosed with a carrier.

In one preferred embodiment, the free-radical initiator is dosed with a carrier in an extruder, wherein the free-radical initiator is present in an amount ranging from 5 to 60 wt. %, based on the total weight of the mixture of the free-radical initiator and the carrier. Suitable carriers may be selected from, but not limited to, talc, calcium carbonate, magnesium carbonate, silica, alumina, and others aluminosilicate. In an alternative embodiment, elastomers, olefinic plastomers or polyethylene masterbatches, may be also used as suitable carriers, such as commercially available products named Vistamaxx™, Engage™, Exact™, Affinity™, Exceed™.

In one or more embodiments, the method for preparing a shrink film according to the present invention further comprises a step of adding a virgin polyethylene resin selected from the group comprising a virgin high-density polyethylene (HDPE) and a virgin low-density polyethylene (LDPE) to the polyethylene-based PCR before the modification step. This can be done with the aim at improving some final properties of the PCR, depending on the initial properties of the PCR source and the desired application.

In an alternative embodiment, the method further comprises a step of blending a virgin polyethylene resin, i.e., HDPE or LDPE, to the modified polyethylene-based PCR before the step of preparing the shrink film in order to improve the desired final properties, such as stiffness of the material.

### EXAMPLES

### Example 1

### I) Preparation of the Modified Polyethylene-Based Post-Consumer Resin (PCR)

Two polyethylene-based PCRs were used in the examples. PCR-A is sourced from plastic waste used in stretch films and PCR-B is sourced from a mixed plastic waste used either in shrink films or stretch films.

TABLE 1

| PCR Sample | MFR (g/10 min) | Estimated amount of LDPE |
|---|---|---|
| PCR-A | 2.5 | <5% |
| PCR-B | 0.8 | ~25% |

Table 1 shows PCR compositions according to one or more embodiments.

The free-radical initiator used was 2,5-dimethyl-2,5-di(tert-butylperoxy)hexane (peroxide 1).

Different samples comprising either PCR-A or PCR-B and the free-radical initiator were prepared in a single screw extruder, with rotation around 30-40 rpm, screen #120 and temperature profile as defined below. Two further samples were made comprising either PCR-A or PCR-B, the free-radical initiator and 30 wt. % of a HDPE PCR to test the influence of a mixture of different sources of PCRs and to bring some stiffness to the film.

TABLE 2

| Zone | Temperature (° C.) |
|---|---|
| 1 | 140 |
| 2 | 210 |
| 3 | 220 |
| 4 | 220 |
| 5 | 200 |

Table 2 shows extruder profile temperatures according to one or more embodiments.

TABLE 1

| Amt. of | PCR-A | | | PCR-B | | |
|---|---|---|---|---|---|---|
| peroxide | | | Mass | | | Mass |
| added in | Amp. | Pressure | temp. | Amp. | Pressure | temp. |
| extruder | (A) | (bar) | (° C.) | (A) | (bar) | (° C.) |
| 230 ppm | 40 | 125 | 218 | 43 | 132 | 229 |
| 450 ppm | 42 | 143 | 217 | 47 | 143 | 230 |
| 670 ppm | 41 | 150 | 220 | 49 | 153 | 235 |
| HDPE | 40 | 114 | 231 | 40 | 127 | 234 |
| 30% + | | | | | | |
| 450 ppm | | | | | | |

Table 3 shows processing conditions according to one or more embodiments.

### II) Analysis on the Modified PCRs

### i) PCR-A

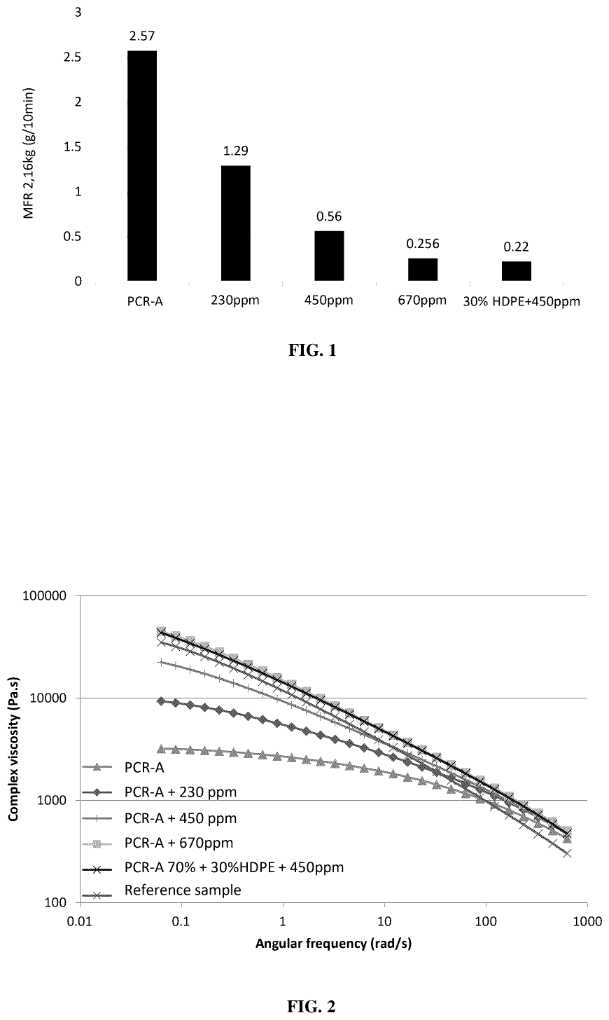

FIG. 1 shows the influence of the modification on the MFR of the PCR-A. It is observed that the presence of HDPE in the mixture results in a decrease in IF similar to a modification level.

FIG. 2 shows a viscosity analysis of PCR-A. In FIG. 2, an increase in viscosity occurs mainly at low frequencies, indicative of a branching process and generation of fractions of high molar mass. Reference sample is a material commonly used for shrink films, with high amounts of LDPE. Reference sample comprises virgin resins with the following amounts: 40% LDPE, 20% HDPE e 40% LLDPE.

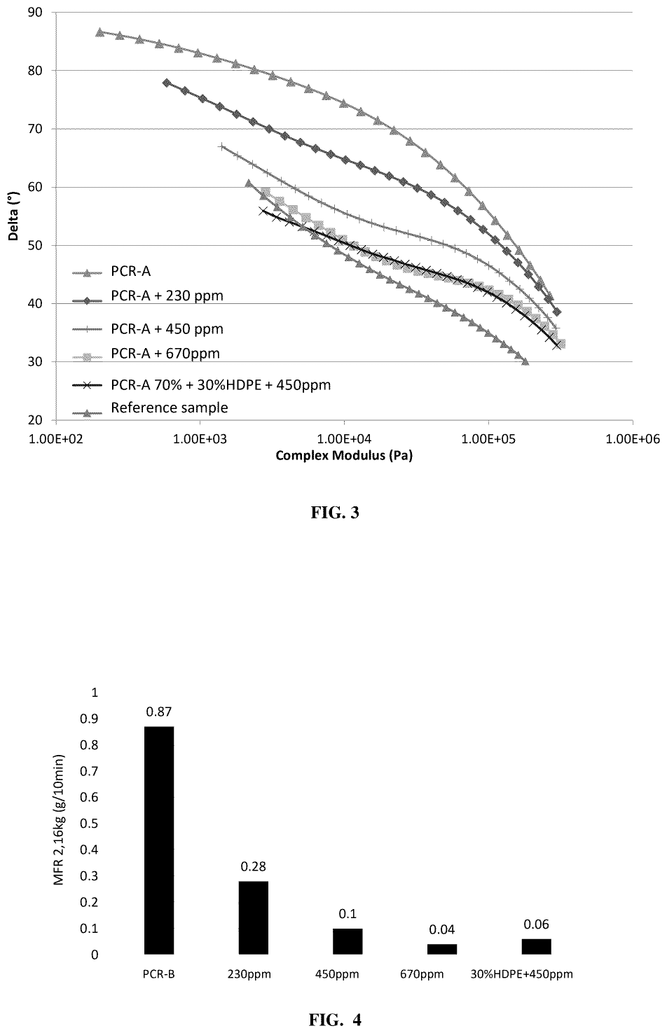

FIG. 3 shows the analysis on the elasticity of the samples, in molecular terms, through the Van Gurp Palmen graph, where the response profile of materials of different viscosities can be compared. The response profile of the PCR-A without modification is similar of a LLDPE or linear polymers, with low elasticity and a soft continuous profile. In comparison with the reference sample, it is observed that for the same complex module, the Delta value is much lower, indicating the presence of elastic elements in the polymer mass. Since reference sample is a composition rich in LDPE, it is known that they are branched molecules.

When promoting the modification of the PCR-A with the free-radical initiator, an increase in the elasticity of the system is observed with a non-continuous transition, as the formation of branches always generate units of high molar mass−Mw (detected in low frequency oscillations). Thus, the presence of LDPE provides elasticity in all Mw ranges, while the modification with the free-radical initiator only provides elasticity in high Mw fractions. The presence of HDPE seems to not change the elasticity profile.

When promoting the modification of the PCR-A with the free-radical initiator, an increase in the elasticity of the system is observed with a non-continuous transition, as the formation of branches always generate units of high molar mass−Mw (detected in low frequency oscillations). Thus, the presence of LDPE provides elasticity in all Mw ranges, while the modification with the free-radical initiator only provides elasticity in high Mw fractions. The presence of HDPE seems to not change the elasticity profile.

### ii) PCR-B

FIG. 4 shows the influence of the modification on the MFR of the PCR-B. It is noted in FIG. 4 that low amounts of the free-radical initiator can decrease the MFR of PCR-B. This rapid decrease is possibly due because PCR-B has a higher amount of LDPE in its composition, around 25%, than PCR-A, and consequently it has already some branches before the modification.

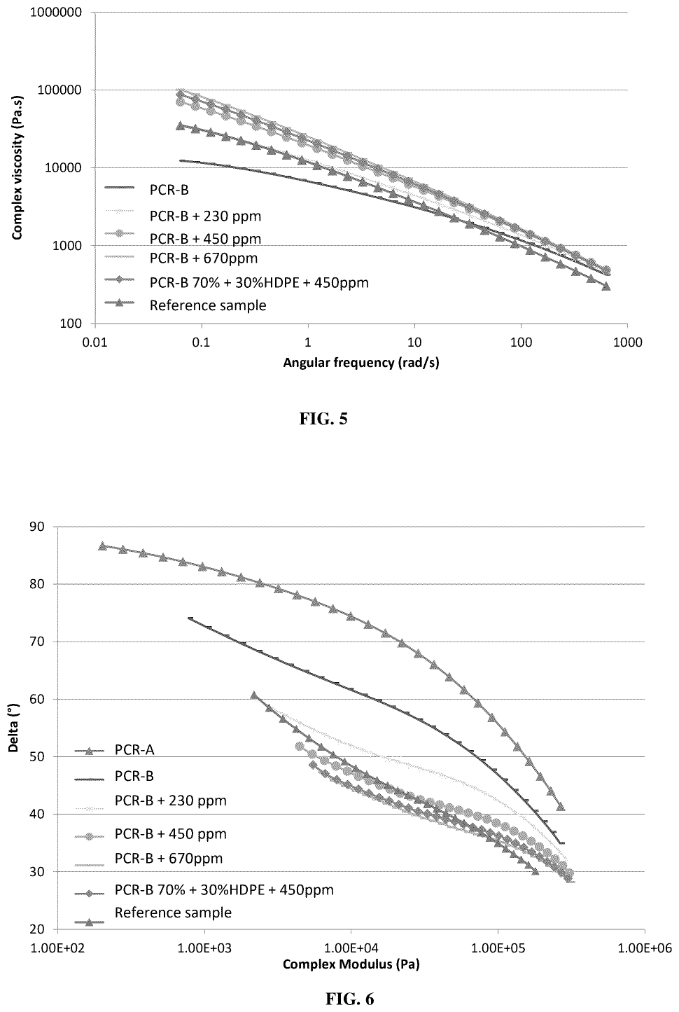

FIG. 5 shows a viscosity analysis of PCR-B. In FIG. 5, one can observe that the modified samples generally presented viscosities greater than the reference sample, thus evidencing the presence of the branches in the PCR-B.

FIG. 6 shows an analysis on the elasticity of the samples, in molecular terms, through the Van Gurp Palmen graph. As well as the elasticity analysis for PCR-A, when analyzing the elasticity of the PCR-B samples, in molecular terms, using the Van Gurp Palmen graph as showed in FIG. 6, it is noted a more elastic characteristic, in addition to a higher viscosity. It is possibly explained by the presence of about 25% of LDPE in the mixture.

The rheological profile resulting from the modification of PCR-B has the same characteristic as PCR-A, tending to form branched molecules of high molar mass, through the formation of branches.

The addition of HDPE did not change the profile significantly, probably because the viscosity relationship between the components allowed adequate mixing and then a similar reaction in the phases, thereby resulting in high viscosities.

### III) Preparation of Shrink Films Comprising PCR-A and PCR-B

For preparing the shrink films, the pattern of 60 μm was used with the following machine parameters.

TABLE 4-1

| | | | Mass | Mass |
|---|---|---|---|---|
| | | | Temperature | Pressure |
| | Temperatures | Rotation | (° C.) | (bar) |
| PCR-A | 170/190/200/210/210/210/201 | 55 | 221 | 87 |
| PCR-A + 230 ppm | 170/190/200/210/210/210/200 | 55 | 221 | 110 |
| PCR-A + 450 ppm | 170/190/200/210/210/210/201 | 55 | 221 | 135 |
| PCR-A + 670 ppm | 170/190/200/210/210/210/201 | 55 | 221 | 153 |
| PCR-B | 170/190/200/210/210/210/20 | 55 | 221 | 140 |
| PCR-B + 230 ppm | 170/190/200/210/210/210/204 | 55 | 221 | 163 |
| PCR-B + 450 ppm | 170/190/200/210/210/210/202 | 55 | 221 | 190 |
| PCR-B + 670 ppm | 170/190/200/210/210/210/202 | 55 | 222 | 205 |
| PCR-A 70% + flake | 170/195/210/215/220/220/207 | 55 | 231 | 153 |
| PEAD 30% + 450 ppm* | | | | |

*It was not possible to make the shrink film with PCR-B 70% + flake PEAD 30% + 450 ppm, since the material showed high viscosity and multiple ruptures.

TABLE 4-2

| | | Frost- | |
|---|---|---|---|
| | | line | Blow |
| | Temperatures | (mm) | ratio |
| PCR-A | 170/190/200/210/210/210/201 | 230 | 2.5 |
| PCR-A + 230 ppm | 170/190/200/210/210/210/200 | 230 | 2.5 |
| PCR-A + 450 ppm | 170/190/200/210/210/210/201 | 230 | 2.5 |
| PCR-A + 670 ppm | 170/190/200/210/210/210/201 | 200 | 2.5 |
| PCR-B | 170/190/200/210/210/210/20 | 200 | 2.5 |
| PCR-B + 230 ppm | 170/190/200/210/210/210/204 | 200 | 2.5 |
| PCR-B + 450 ppm | 170/190/200/210/210/210/202 | 200 | 2.5 |
| PCR-B + 670 ppm | 170/190/200/210/210/210/202 | 200 | 2.5 |
| PCR-A 70% + flake | 170/195/210/215/220/220/207 | 230 | 2.5 |
| PEAD 30% + 450 ppm* | | | |

*It was not possible to make the shrink film with PCR-B 70% + flake PEAD 30% + 450 ppm, since the material showed high viscosity and multiple ruptures.

Table 4 shows machine parameters for producing shrink films according to one or more embodiments.

Similar to what was observed in rheology, the mass pressure was indicative of the viscosity of the materials.

### IV) Properties of the Prepared Films

### Shrinkage (Measured According to ASTM D2732 and ASTM D1204)

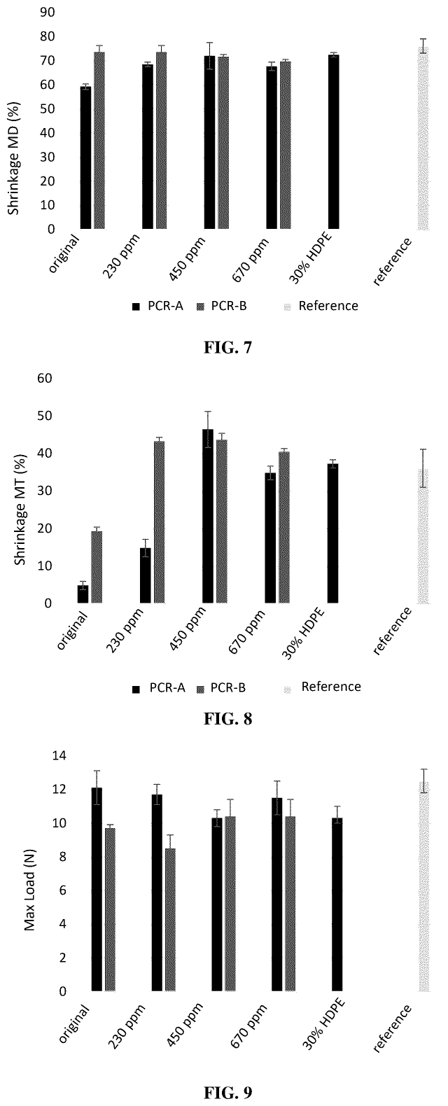

FIG. 7 shows shrinkage in the machine direction for the prepared films modified with peroxide 1.

FIG. 8 shows shrinkage in the transverse direction for the prepared films modified with peroxide 1.

As shown in FIGS. 7 and 8, for both PCR-A and PCR-B, it was possible to generate samples with suitable shrinkage. It should be noted that for the base material PCR-A, the most suitable shrinkage degree was achieved in the transverse direction (MT) with 450 ppm of the free-radical initiator, while for the base material PCR-B, the main requirement for shrink films was reached with 230 ppm. The presence of HDPE in the mixture does not seem to influence in the shrinkage.

### Puncture Resistance (Measured According to ASTM D1306)

FIG. 9 shows puncture resistance at maximum load for the prepared films.

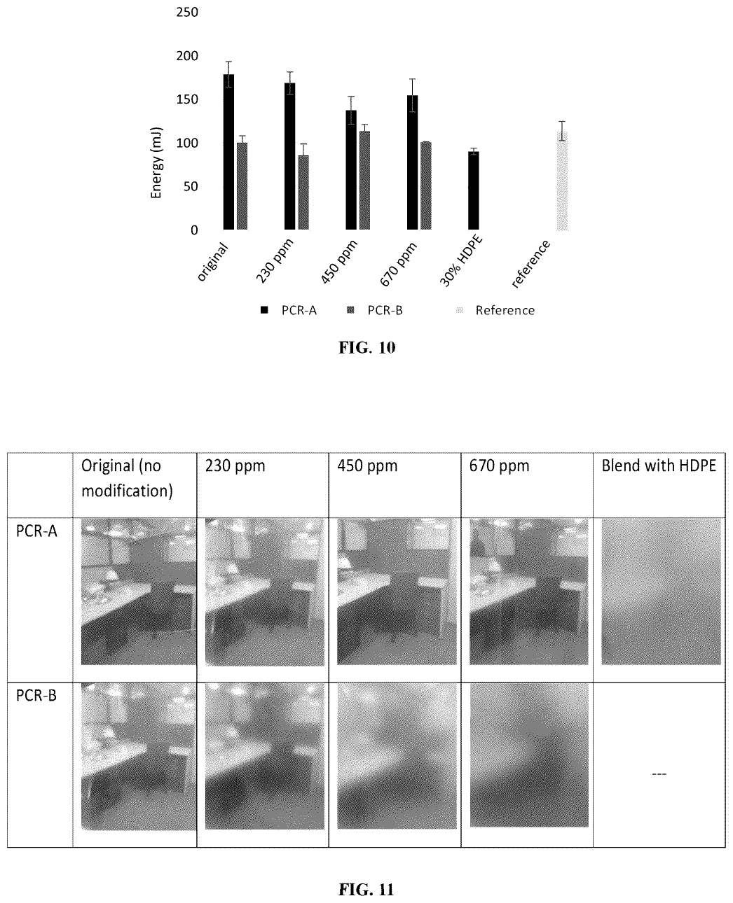

FIG. 10 shows puncture resistance total energy for the prepared films.

As shown in FIGS. 9 and 10, the formulations do not seem to interfere with the characteristics of the films in terms of maximum load and total energy of the samples. Again, it is not possible to observe any influence of adding HDPE to the modifications

### Transparency of the Films

FIG. 11 shows images of the prepared films, demonstrating film transparency. The effect of the modification is evident in samples comprising PCR-B, where the greater the modification, the greater the opacity. For PCR-A samples, this does not occur, and there was an increase in opacity only when adding HDPE flakes.

It was also not possible to identify an increase in the number of gels in the films with the modification, something important due to the peroxide carrier being in silica and the concentration being able to generate high weight gels. However, there was not such increase in the number of gels in the films, thus indicating that there was good dispersion before the reaction. Depending on the source of the PCR used, a film with low transparency and improved shrinkage can be obtained.

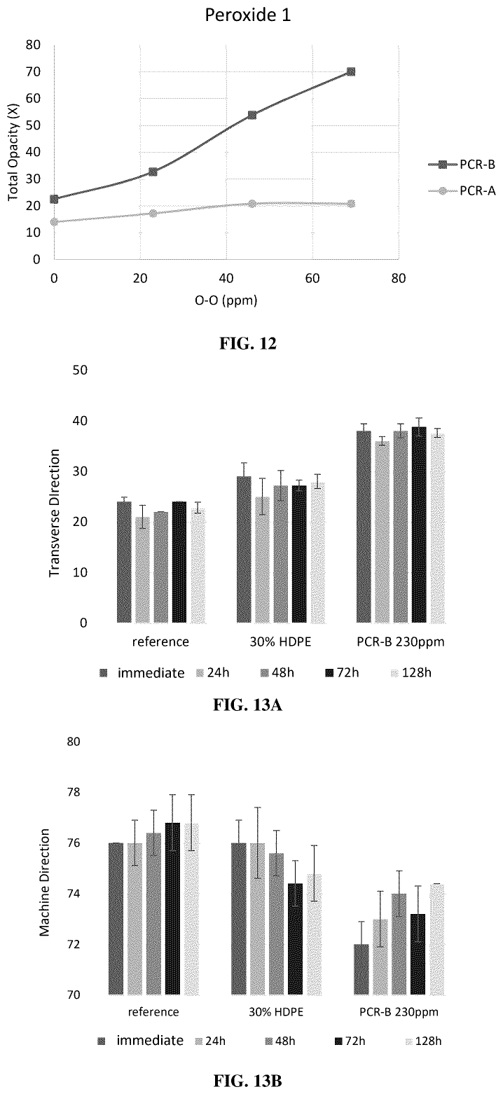

FIG. 12 shows a chart representing the opacity effect in PCR-A and PCR-B observed in FIG. 11. Using PCR-A it is possible to reach not only an improved shrink film but also a high transparency grade, suitable to more sophisticated application. Depending on the source of the PCR used, the present invention allows the production of a film with low transparency and improved shrinkage.

### Stability in the Shrinkage

FIGS. 13A-B shows the shrink properties of the films obtained from the modified PCR according to the present invention (machine direction and transversal direction) throughout the time. A time observation of the shrinkage modified PCR-B film was followed to avoid a possible film relaxation effect, which could be just a consequence of the processing. As can be seen in FIG. 13, the shrinkage properties of modified PCR-B film were maintained throughout the time, demonstrating stability in the shrinkage. Also, it can be noted that shrinkage of modified PCR-B film was higher than the reference recipe in transversal direction, while maintained similar performance as the reference in machine direction.

### Example 2

### I) Preparation of the Modified Polyethylene-Based Post-Consumer Resin (PCR)

Example 2 was prepared using a different free-radical initiator, less reactive than the initiator used in example 1, in the same equipment. The free-radical initiator used in this example was 3,3,5,7,7-Pentamethyl-1,2,4-trioxepane (peroxide 2).

The direct comparison of the peroxide compounds in same quantity is not correct, since each peroxide compound may have different content of active oxygen that will react and generate free radicals. To overcome this issue, it was normalized using the molecular weight and active Oxygen criteria, which means the active oxygen available to react in the reactive extrusion, considering also the purity declared by the supplier. So, the equivalent amount of the peroxide compounds considering the active Oxygen criteria is defined in the table below in ppm.

TABLE 5

| active oxygen (ppm) | peroxide 1 (ppm) | peroxide 2 (ppm) |
|---|---|---|
| 23 | 230 | 260 |
| 46 | 450 | 520 |
| 69 | 670 | 780 |

Table 5 is a comparison between peroxide 1 and peroxide 3 in terms of active oxygen criteria.

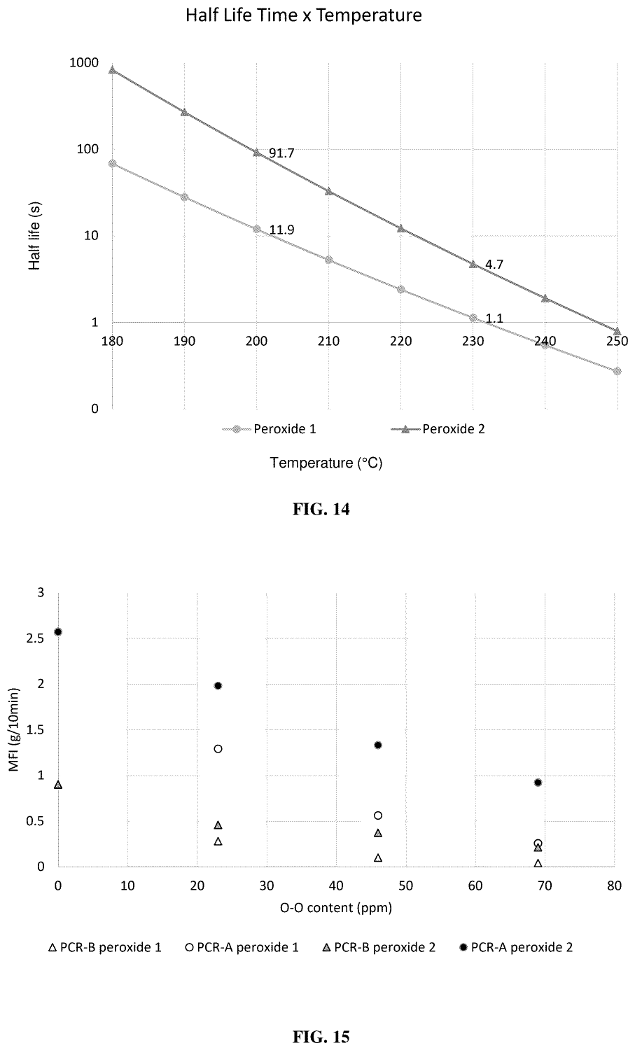

FIG. 14 shows the half life versus temperature of peroxide 1 and peroxide 2.

The reactivity difference between peroxide 1 and 2 are observed in FIG. 14 below, in terms of half-life. The major difference is in the range of 180-220° C., in the earlier stages of the polymer melting and mixture.

TABLE 6-1

| | PCR A | | |
|---|---|---|---|
| | Amperage | Pressure | Mass Temperature |
| | (A) | (bar) | (° C.) |
| referance | 41 | 125 | 220 |
| 23 ppm O—O | 40 | 125 | 218 |
| 46 ppm O—O | 42 | 143 | 217 |
| 69 ppm O—O | 41 | 150 | 220 |

TABLE 6-2

| | PCR B | | |
|---|---|---|---|
| | Amperage | Pressure | Mass Temperature |
| | (A) | (bar) | (° C.) |
| referance | 49 | 138 | 226 |
| 23 ppm O—O | 43 | 132 | 229 |
| 46 ppm O—O | 47 | 143 | 230 |
| 69 ppm O—O | 49 | 153 | 235 |

Table 6 shows the processing conditions using peroxide 2, in terms of active oxygen criteria.

### II) Analysis of the Modified PCRs

FIG. 15 shows a comparison of MFR reduction of PCRs A and B, using peroxide 1 and peroxide 2.

As can be seen in FIG. 15, peroxide 1, which has higher reactivity than peroxide 2, seems to cause a more efficient degradation of PCRs in terms of MFR reduction. Nevertheless, FIG. 15 also shows that, although peroxide 2 has a much lower reactivity with the PCRs samples A and B, it still works for the purpose of decreasing the melt flow index of different PCRs.

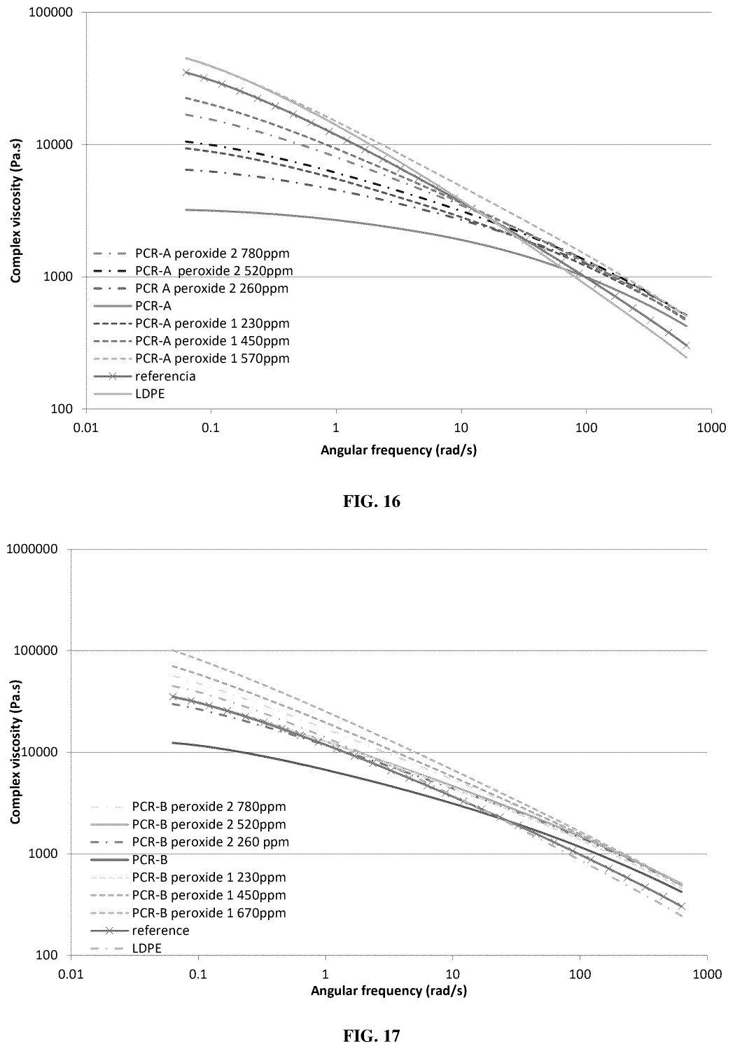

FIG. 16 shows a viscosity analysis of PCR-A modified with peroxide 1 and peroxide 2.

FIG. 17 shows a viscosity analysis of PCR-B modified with peroxide 1 and peroxide 2.

Analogously to MFR analysis, the effectiveness of peroxide 1 seems to be higher. Specially for PCR-A, it follows almost the same elastic behavior, comparing 230 ppm of peroxide 1 and 520 ppm of peroxide 2, leading to similar MFR, viscosity and elasticity profiles.

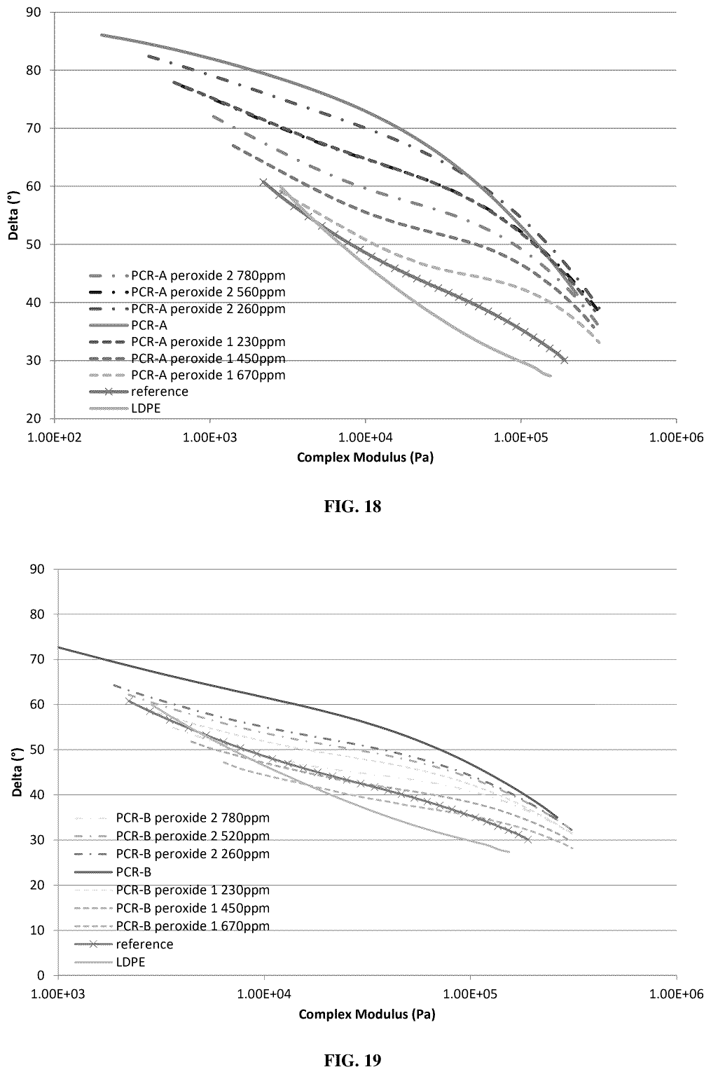

FIG. 18 shows the analysis and comparison on the elasticity of samples PCR-A modified with peroxide 1 and peroxide 2, in molecular terms, through the Van Gurp Palmen graph, where the response profile of materials of different viscosities can be compared.

FIG. 19 shows the analysis and comparison on the elasticity of samples PCR-B modified with peroxide 1 and peroxide 2, in molecular terms, through the Van Gurp Palmen graph, where the response profile of materials of different viscosities can be compared.

It can be noted that peroxide 2 was also capable of modifying the resin, although presenting a lower efficiency when compared to the modification using peroxide 1.

### III) Preparation of Shrink Films Comprising PCR-A and PCR-B

TABLE 7-1

| | | | Mass | Mass |
|---|---|---|---|---|
| | | | Temp. | Pressure |
| | Temperatures | Rotation | (° C.) | (bar) |
| PCR-A | 170/190/200/210/210/210/200 | 58 | 220 | 148 |
| peroxide 2 | | | | |
| 260 ppm | | | | |
| PCR-A | 170/190/200/210/210/210/201 | 58 | 221 | 152 |
| peroxide 2 | | | | |
| 520 ppm | | | | |
| PCR-A | 170/190/200/210/210/210/201 | 58 | 221 | 166 |
| peroxide 2 | | | | |
| 780 ppm | | | | |
| PCR-B | 170/190/200/210/210/210/204 | 58 | 217 | 109 |
| peroxide 2 | | | | |
| 260 ppm | | | | |
| PCR-B | 170/190/200/210/210/210/202 | 58 | 220 | 122 |
| peroxide 2 | | | | |
| 520 ppm | | | | |
| PCR-B | 170/190/200/210/210/210/202 | 58 | 221 | 121 |
| peroxide 2 | | | | |
| 780 ppm | | | | |

TABLE 7-2

| | | Fog | Blow |
|---|---|---|---|
| | Temperatures | line (mm) | ratio |
| PCR-A peroxide 2 | 170/190/200/210/210/210/200 | 200 | 2.5 |
| 260 ppm | | | |
| PCR-A peroxide 2 | 170/190/200/210/210/210/201 | 200 | 2.5 |
| 520 ppm | | | |
| PCR-A peroxide 2 | 170/190/200/210/210/210/201 | 200 | 2.5 |
| 780 ppm | | | |
| PCR-B peroxide 2 | 170/190/200/210/210/210/204 | 200 | 2.5 |
| 260 ppm | | | |
| PCR-B peroxide 2 | 170/190/200/210/210/210/202 | 200 | 2.5 |
| 520 ppm | | | |
| PCR-B peroxide 2 | 170/190/200/210/210/210/202 | 200 | 2.5 |
| 780 ppm | | | |

For preparing the shrink films, the pattern of 60 μm was used with the machine parameters shown in Table 7.

### IV) Properties of the Prepared Films

### Shrinkage (Measured According to ASTM D2732 and ASTM D1204)

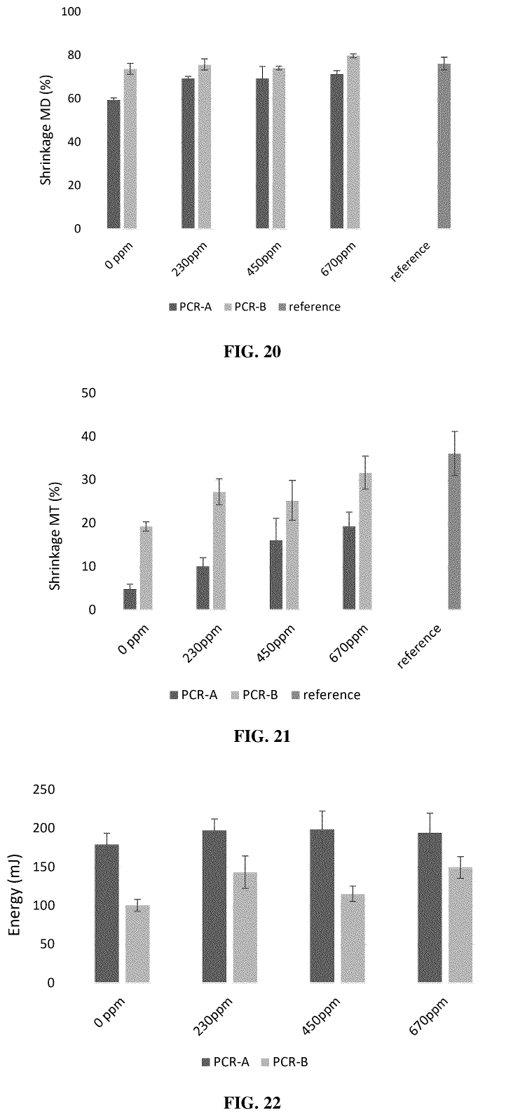

FIG. 20 shows shrinkage in the machine direction for the prepared films modified with peroxide 2.

FIG. 21 shows shrinkage in the transverse direction for the prepared films modified with peroxide 2.

The shrinkage improvement is evident to both samples PCR-A and PCR-B, as can be seen in FIGS. 20 and 21. In contrast to the films modified with peroxide 1, the low reactive peroxide results in a smooth modification as the amount of peroxide 2 is added.

### Puncture Resistance (Measured According to ASTM D1306)

FIG. 22 shows puncture resistance at maximum load for the films prepared with peroxide 2.

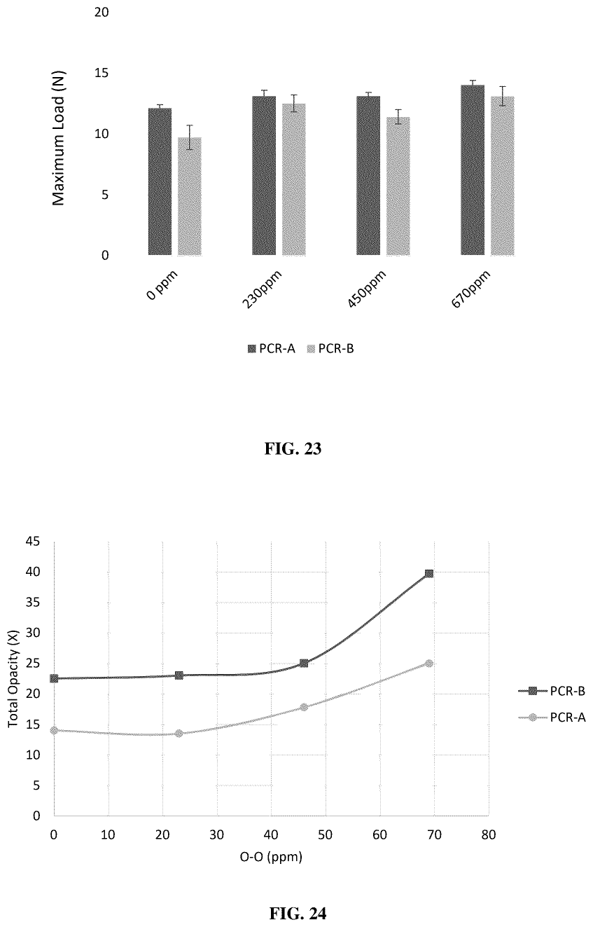

FIG. 23 shows puncture resistance total energy for the films prepared with peroxide 2.

The puncture properties were not affected when using peroxide 2 for the modification of PCR-A and PCR-B, as can be noted in FIGS. 22 and 23. It leads to a possibility of using a composition comprising 100% post-consumer resins for shrink films or some formulation using HDPE to higher stiffness, depending on the required final properties or product specification.

### Transparency of the Films/Opacity

FIG. 24 shows a chart representing the opacity effect in PCR-A and PCR-B when using peroxide 2. Similar to peroxide 1, the increase of the peroxide amount added to the PCR could lead to an increase of the film opacity. However, by using sources of PCRs with higher MFR, it is possible to reach important balance opacity x shrinkage, which has high value for some applications.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures.

What is claimed:

1. A modified polyethylene-based post-consumer resin (PCR) suitable for shrink films, wherein the modified polyethylene-based PCR is a polyethylene-based PCR modified by a free-radical initiator and has a melt flow rate ranging from 0.01 to 1 g/10 min measured according to ASTM D1238 (190° C., 2.16 kg), wherein the free-radical initiator is present in an amount ranging from 100 to 1000 ppm based on the total weight of the modified PCR.

2. The modified polyethylene-based post-consumer resin (PCR) according to claim 1, wherein the free-radical initiator is one or more peroxide compounds being selected from the group consisting of 3-hydroxy-1,1-dimethylbutyl peroxyneodecanoate, a-cumyl peroxyneodecanoate, 2-hydroxy-1,1-dimethylbutyl peroxyneoheptanoate a-cumyl peroxyneoheptanoate, t-amyl peroxyneodecanoate, t-butyl peroxyneodecanoate, di(2-ethylhexyl) peroxydicarbonate, di(n-propyl) peroxydicarbonate, di(sec-butyl) peroxydicarbonate, t-butyl peroxyneoheptanoate, t-amyl peroxypivalate, t-butyl peroxypivalate, diisononanoyl peroxide, didodecanoyl peroxide, 3-hydroxy-1,1-dimethylbutylperoxy-2-ethylhexanoate, didecanoyl peroxide, 2,T-azobis(isobutyronitrile), di(3-carboxypropionyl) peroxide, 2,5-dimethyl-2,5-di(2-ethylhexanoylperoxy)hexane, dibenzoyl peroxide, t-amylperoxy 2-ethylhexanoate, t-butylperoxy 2-ethylhexanoate, t-butyl peroxyisobutyrate, t-butyl peroxy-(cis-3-carboxy)propenoate, 1,1-di(t-amylperoxy)cyclohexane, 1,1-di(t-butylperoxy)-3,3,5-trimethylcyclohexane, 1,1-di(t-butylperoxy) cyclohexane, OO-t-amyl O-(2-ethylhexyl) monoperoxycarbonate, OO-t-butyl O-isopropyl monoperoxycarbonate, OO-t-butyl O-(2-ethylhexyl) monoperoxycarbonate, polyether tetrakis(t-butylperoxycarbonate), 2,5-dimethyl-2,5-di(benzoylperoxy)hexane, t-amyl peroxyacetate, t-amyl peroxybenzoate, t-butyl peroxyisononanoate, t-butyl peroxyacetate, t-butyl peroxybenzoate, di-t-butyl diperoxyphthalate, 2,2-di(t-butylperoxy)butane, 2,2-di(t-amylperoxy)propane, n-butyl 4,4-di(t-butylperoxy)valerate, ethyl 3,3-di(t-amylperoxy)butyrate, ethyl 3,3-di(t-butylperoxy)butyrate, dicumyl peroxide, a,a′-bis(t-butylperoxy)diisopropylbenzene, 2,5-dimethyl-2,5-di(t-butylperoxy) hexane, di(t-amyl) peroxide, t-butyl a-cumyl peroxide, di(t-butyl) peroxide, 2,5-dimethyl-2,5-di(t-butylperoxy)-3-hexyne, dicetil peroxi-dicarbonato, 3,6,9-triethyl-3,6,9-trimethyl-1,4,7-triperoxonane, tert-butylperoxy 2-ethylhexyl carbonate, tert-butyl-peroxide n-butyl fumarate(benzoate), dimyristoyl peroxydiicarbonate, 3,3,5,7,7-pentamethyl-1,2,4-trioxepane, tert-butyl hydroperoxide, bis(4-t-butylcyclohexyl) peroxydicarbonate, and 1,2,4,5,7,8-hexoxonane,3,6,9-trimethyl-3,6,9-tris(ethyl and propyl derivatives).

3. The modified polyethylene-based post-consumer resin (PCR) according to claim 1, wherein the free-radical initiator is one or more nitroxide compounds being selected from 2,2,5,5-tetramethyl-1-pyrrolidinyloxy, 3-carboxy-2,2,5,5-tetramethyl-pyrrolidinyloxy, 2,2,6,6-tetramethyl-1-piperidinyloxy, 4-hydroxy-2,2,6,6-tetramethyl-1-piperidinyloxy, 4-methoxy-2,2,6,6-tetramethyl-1-piperidinyloxy, 4-oxo-2,2,6,6-tetramethyl-1-piperidinyloxy, bis-(1-oxyl-2,2,6,6-tetramethylpiperidine-4-yl)sebacate, 2,2,6,6-tetramethyl-4-hydroxypipe ridine-1-oxyl)monophosphonate, N-tert-butyl-1-diethylphosphono-2,2-dimethyl propyl nitroxide, N-tert-butyl-1-dibenzylphosphono-2,2-dimethylpropyl nitroxide, N-tert-butyl-1-di(2,2,2-trifluoroethyl)phosphono-2,2dimethylpropyl nitroxide, N-tert-butyl-(1-diethylphosphono)-2-methyl-propyl nitroxide, N-(1-methylethyl)-1-cyclohexyl-1-(diethylphosphono) nitroxide, N-(1-phenylbenzyl)-(1-diethylphosphono)-1-methyl ethylnitroxide, N-phenyl-1-diethylphosphono-2,2-dimethyl propyl nitroxide, N-phenyl-1-diethylphosphono-1-methyl ethyl nitroxide, N-(1-phenyl 2-methyl propyl)-1-diethylphosphono-1-methyl ethyl nitroxide, N-tert-butyl-1-phenyl-2-methyl propyl nitroxide, and N-tert-butyl-1-(2-naphthyl)-2-methyl propyl nitroxide.

4. The modified polyethylene-based post-consumer resin (PCR) according to claim 1, wherein the melt flow rate of the modified polyethylene-based PCR ranges from 0.2 to 0.6 g/10 min.

5. The modified polyethylene-based post-consumer resin (PCR) according to claim 1, wherein the modified polyethylene-based PCR is derived from a polyethylene-based PCR having a melt flow rate ranging from 0.5 to 5 g/10 min measured according to ASTM D1238 (190° C., 2.16 kg).

6. The modified polyethylene-based post-consumer resin (PCR) according to claim 1, wherein the polyethylene-based PCR is sourced from plastic waste used in shrink films, stretch films or combinations thereof.

7. The modified polyethylene-based post-consumer resin (PCR) according to claim 6, wherein the polyethylene-based PCR is derived from a mixture of sources containing different PCRs wherein its final composition comprises greater than 50 wt. % of linear low-density polyethylene (LLDPE), 0 to 30 wt. % of low-density polyethylene (LDPE) and from 0 to 40 wt. % of high-density polyethylene (HDPE).

8. The modified polyethylene-based post-consumer resin (PCR) according to claim 1, wherein the free-radical initiator is present in an amount ranging from 150 to 700 ppm based on the total weight of the PCR.

9. The modified polyethylene-based post-consumer resin (PCR) according to claim 1, wherein the modification occurs via reactive extrusion or via a mixture vessel.

10. A shrink film comprising a modified polyethylene-based post-consumer resin (PCR), wherein the modified polyethylene-based PCR is a polyethylene-based PCR modified by a free-radical initiator and has a melt flow rate ranging from 0.01 to 1 g/10 min measured according to ASTM D1238 (190° C., 2.16 kg), wherein the free-radical initiator is present in an amount ranging from 100 to 1000 ppm based on the total weight of the modified PCR.

11. The shrink film according to claim 10, wherein the modified polyethylene-based post-consumer resin (PCR) is according to claim 1.

12. The shrink film according to claim 10, further comprising up to 40 wt. % of a virgin polyethylene resin selected from the group comprising a virgin high-density polyethylene (HDPE) and a virgin low-density polyethylene (LDPE).

13. The shrink film according to claim 10, further comprising at least one additive selected from fillers, antioxidants, pigments, antiblockage, UV protectors and antibacterial.

14. The shrink film according to claim 10, having a MD shrinkage of from 60 percent to 80 percent and a TD shrinkage of from at least 20 percent, measure according to ASTM D2732 and ASTM D1204.

15. An article wrapped by the shrink film according to claim 10.

16. A method for preparing a shrink film comprising a modified polyethylene-based PCR, comprising:
modifying a polyethylene-based PCR by a free-radical initiator via reactive extrusion or via a mixture vessel, wherein the free-radical initiator is added in an amount ranging from 100 to 1000 ppm based on the total weight of the PCR, and
prepare the shrink film having a MD shrinkage of from 60 percent to 80 percent and a TD shrinkage of from at least 20 percent.

17. The method for preparing a shrink film according to claim 16, wherein the modification occurs at moderate temperatures from above 120° C. to below 300° C., preferably from 150 to 280° C.

18. The method for preparing a shrink film according to claim 16, wherein the free-radical initiator is added i) directly to the polyethylene-based PCR in an extruder or in a mixture vessel, or ii) it is dosed with a carrier.

19. The method for preparing a shrink film according to claim 18, wherein the free-radical initiator is dosed with a carrier in an extruder, wherein the free-radical initiator is present in an amount ranging from 5 to 60 wt. %, based on the total weight of the mixture of the free-radical initiator and the carrier.
